(19) United States
(12) Patent Application Publication
(10) Pub. No.: US 2008/0099125 A1
(43) Pub. Date: May 1, 2008

(54) Pressure loader for firing laminated ceramic substrate and method of manufacturing the laminated ceramic substrate using the same

(75) Inventor: Beom Joon Cho, Yongin (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 11/907,015

(22) Filed: Oct. 9, 2007

(30) Foreign Application Priority Data
Oct. 26, 2006 (KR) 10-2006-0104603

(51) Int. Cl. C03B 29/00; B23K 37/00

(52) U.S. Cl. 156/89.11; 156/580

(57) ABSTRACT

A pressure loader for firing a laminated ceramic substrate includes an outer loader and an inner loader. The outer loader is mounted on a periphery region of a ceramic laminated body to press the periphery region, and the inner loader is mounted on an internal region of the ceramic laminated body to press the internal region.

### CROSS-REFERENCE TO RELATED APPLICATIONS

This application claims the priority of Korean Patent Application No. 2006-104603, filed on Oct. 26, 2006, in the Korean Intellectual Property Office, the disclosure of which is incorporated herein by reference.

### BACKGROUND OF THE INVENTION

1. Field of the Invention

The present invention relates to a loader for firing a laminated ceramic substrate and a method of manufacturing the laminated ceramic substrate using the same. In particular, a ceramic laminated body is fired in such a state that a periphery region is pressed at a higher pressure than an internal region, thereby obtaining a flat ceramic substrate after the firing process.

2. Description of the Related Art

Since laminated ceramic substrates using glass-ceramic can be used to configure circuits with three-dimensional structures and form a cavity, a plurality of devices having various functions can be embedded with high design flexibility. Hence, the laminated ceramic substrates are widely used in the miniaturized and multifunctional RF parts.

While simple RF elements and low-capacity inductor and capacitor elements can be embedded, high-capacity capacitors for power decoupling do not exhibit satisfactory characteristics due to the limitation of material and process. A hetero-junction is used for inserting a high-capacity dielectric layer between low-dielectric-constant interconnections. However, the substrate may be bent or lifted off in co-firing the hetero-junction due to different firing shrinkage behaviors.

Defects of the substrates due to the different shrinkage behaviors can be reduced by constrained-sintering of the junction substrate. For example, one method is to suppress x-y shrinkage by attaching flexible constraining layers to the top and bottom surfaces of the laminated body. Another method is to suppress the shrinkage by applying a large load on the substrate during the firing process. In addition, the two methods can be used together.

In case where the flexible constraining layers are attached on the top and bottom surfaces of the laminated body and then fired, the substrate may be distorted during the firing process if the constraining layer is not greatly higher than the laminated body. If the thickness of the constraining layer increases so as to prevent the distortion of the substrate, the release of organic materials and volatile materials generated at the laminated ceramic body during the firing process is limited, thus deteriorating the firing characteristics.

In case where the pressure firing process using a load is performed, x-y shrinkage is suppressed only by pressure. Therefore, very high pressure is applied to the substrate. Due to the deficiency of paths for the release of organic materials or the like, the laminated body may be damaged during the firing process, or the firing characteristics may be deteriorated. In case where the two methods are used together, a thin constraining layer is attached on the surface of the laminated body and a low load is applied to the laminated body so as to prevent its damage. However, when the constraining layer is attached and the pressure firing process is performed thereon, particles located around the outermost periphery of the laminated body are exposed to outside air. Thus, the binding force due to adjacent particles is weakened compared with particles inside the laminated body. The binding force is also weakened in particles located around the periphery regions contacting the outside air. Due to the weakened binding force, there exists a region having a shrinkage behavior different from the inside of the laminated body. Compared with the internal region, the x-y shrinkage is increased and the volume shrinkage is constantly maintained in the periphery region of the laminated body having the weakened binding force. Hence, the shrinkage in a thickness direction is reduced. That is, compared with the internal region, the thickness of the region defined within a predetermined distance from the outer periphery of the laminated body is less shrunken. Therefore, after the firing process, the center of the substrate becomes thin, while the periphery of the substrate becomes thick. If the inside of the laminated body becomes thin during the firing process, the pressure surface and the surface of the laminated body are separated from each other so that the internal region of the laminated body becomes non-pressed state. Since the x-y shrinkage is suppressed only by the constraining layer, the effect due to the pressure disappears and thus the shrinkage rate is increased in the inside of the laminated body. Further, the surface of the laminated body is planarized for mounting integrated circuits (ICs). At this point, since the inside of the laminated body temporarily becomes non-pressed state during the firing process, the planarization of the laminated body is deteriorated and the outer periphery becomes thick after the firing process. Consequently, it takes a lot of time to perform a wrapping process for planarization.

### SUMMARY OF THE INVENTION

An aspect of the present invention provides a pressure loader for firing a laminated ceramic substrate, which can reduce the difference of a shrinkage rate between a periphery region and an internal region of a ceramic laminated body by separately pressing the periphery region and the internal region during a process of firing the ceramic laminated body.

An aspect of the present invention also provides a method of manufacturing a laminated ceramic substrate having a flat surface by using the pressure loader.

According to an aspect of the present invention, there is provided a pressure loader for firing a laminated ceramic substrate, including: an outer loader mounted on a periphery region of a ceramic laminated body to press the periphery region; and an inner loader mounted on an internal region of the ceramic laminated body to press the internal region.

The outer loader may have an opening at a portion corresponding to the internal region of the ceramic laminated body. The internal loader may have a block shape such that the internal loader is inserted into the opening of the outer loader.

The top surface of the outer loader may be higher than that of the inner loader when the outer loader is mounted on the periphery region of the ceramic laminated body.

The pressure loader may further include a top loader mounted on the outer loader to press the outer loader.

The top loader may have a grid structure and may have a predetermined elasticity such that the top loader simultaneously presses the outer loader and the inner loader. According to another aspect of the present invention, there is provided a method of manufacturing a laminated ceramic substrate, including: laminating a plurality of green sheets to form a ceramic laminated body; primarily pressing the ceramic laminated body such that a periphery region of the ceramic laminated body is formed lower than an internal region of the ceramic laminated body; and firing the ceramic laminated body in such a state that the periphery region and the internal region of the primarily pressed ceramic laminated body are secondarily pressed.

The primarily pressing may be performed using a jig to press the periphery region of the ceramic laminated body. The jig may be a flat jig having a ridge at a portion corresponding to the periphery region of the ceramic laminated body.

The firing process may be performed using separate loaders mounted on the periphery region and the internal region of the ceramic laminated body. The loaders may include: an outer loader for pressing the periphery region of the ceramic laminated body; and an inner loader for pressing the internal region of the ceramic laminated body.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is an exploded perspective view illustrating a loader for firing a laminated ceramic substrate according to an embodiment of the present invention;

FIGS. 2(a) to 2(c) are perspective views illustrating a method of manufacturing a laminated ceramic substrate according to an embodiment of the present invention;

FIG. 3(a) is a graph illustrating the comparison of a shrinkage rate between a laminated ceramic substrate according to the related art and a laminated ceramic substrate according to the embodiment of the present invention;

FIG. 3(b) is a graph illustrating the comparison of the camber between a laminated ceramic substrate according to the related art and a laminated ceramic substrate according to the embodiment of the present invention; and

FIG. 4 is a cross-sectional view illustrating the comparison between the laminated ceramic substrate according to the embodiment of the present invention and the laminated ceramic substrate according to the related art.

### DETAILED DESCRIPTION OF THE PREFERRED EMBODIMENT

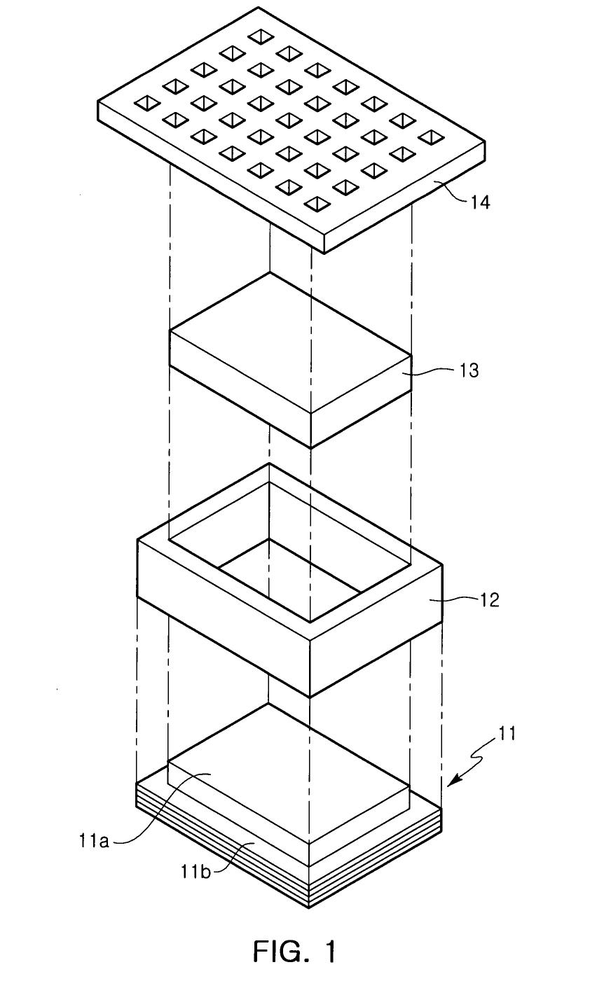

Exemplary embodiments of the present invention will now be described in detail with reference to the accompanying drawings. FIG. 1 is an exploded perspective view illustrating a pressure loader for firing a laminated ceramic substrate according to an embodiment of the present invention.

Referring to FIG. 1, the pressure loader for firing the laminated ceramic substrate includes an outer loader 12, an inner loader 13, and a top loader 14.

In using the pressure loader, a periphery region 11b of a ceramic laminated body 11 to be fired is pressed at a higher pressure than an internal region 11a, whereby the periphery region 11b is formed lower than the internal region 11a.

To obtain the ceramic laminated body 11 of FIG. 1, a plurality of green sheets are laminated and a pressure jig is used to press the periphery region 11b of the laminated body 11 at a higher pressure than the internal region 11a. Examples of the pressure jig include a flat jig having a ridge at a portion coming in contact with the periphery region 11b of the laminated structure 11.

The pressure loader is used in firing the ceramic laminated body 11 that has experienced the laminating and pressing processes. The x-y shrinkage of the laminated body 11 can be prevented by applying the pressure the top surface of the ceramic laminated body 11 during the firing process.

In this embodiment, the outer loader 12 is mounted on the periphery region 11b of the ceramic laminated body 11, and the inner loader 13 is mounted on the internal region 11a of the ceramic laminated body 11. The periphery region 11b and the internal region 11a of the ceramic laminated body 11 are separately pressed during the firing process.

The outer loader 12 has an opening at a portion corresponding to the internal region 11a of the laminated ceramic substrate 11, such that it presses only the periphery region 11b of the pressed laminated ceramic substrate 11.

The inner loader 13 has a block shape corresponding to the internal region 11a of the laminated ceramic substrate 11, such that it presses only the internal region 11a of the pressed laminated ceramic substrate 11.

The inner loader 13 is inserted into the opening of the outer loader 12.

The inner loader 13 and the outer loader 12 may be formed of refractory oxides or alloys thereof. The inner loader 13 and the outer loader 12 may be formed in various shapes only if they are separately pressed.

The top loader 14 may be mounted on the inner loader 13 and the outer loader 12, such that the inner loader 13 and the outer loader 12 can be simultaneously pressed.

It is desirable that the top surface of the outer loader 12 is higher than the top surface of the inner loader 13 after mounting the inner loader 13 and the outer loader 12 on the laminated ceramic substrate 11. In this case, the top loader 14 comes in contact with the top surface of the outer loader 12, whereby only the outer loader 12 is pressed.

By pressing the outer loader 12 through the top loader 14, the periphery region 11b having a weak binding force can be pressed at a higher pressure than the internal region 11b. Therefore, the shrinkage difference between the internal region 11a and the periphery region lib can be reduced and the entirely flat substrate can be obtained.

The top loader 14 may have a porous grid structure. In this case, organic materials or volatile components generated during the process of firing the laminated ceramic substrate can be more easily released.

Further, the top loader 14 may have a predetermined elasticity so as to compensate the height difference between the inner loader 13 and the outer loader 12.

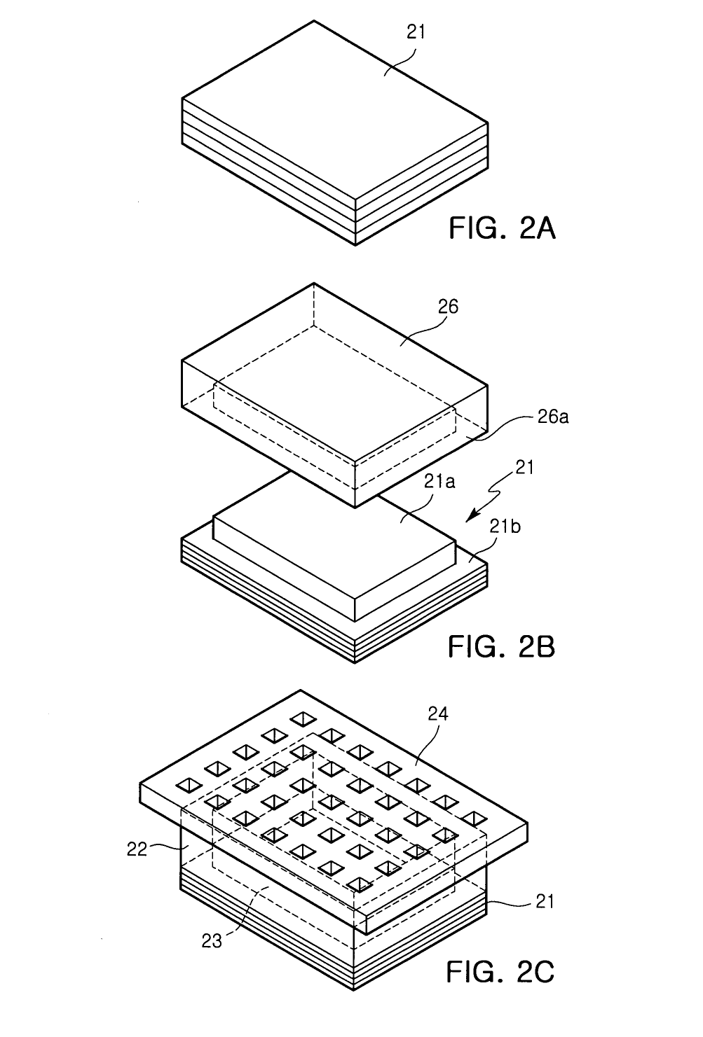

FIGS. 2(a) to 2(c) are perspective views illustrating a method of manufacturing a laminated ceramic substrate according to an embodiment of the present invention.

The method of manufacturing the laminated ceramic substrate includes forming a laminated body, pressing the surface of the laminated body such that a periphery region is formed lower than an internal region, and performing a firing process while separately pressing the periphery region and the internal region of the laminated body.

FIG. 2(a) illustrates a process of forming a ceramic laminated body 21 in which a plurality of green sheets are laminated. Referring to FIG. 2(a), the ceramic laminated body 21 is formed by laminating a plurality of green sheets. Internal electrode patterns are formed between the laminated electrode patterns. The internal electrode patterns are connected together through conductive via holes penetrating the green sheets.

The process of forming the ceramic laminated body 21 may include: forming internal electrodes by printing, depositing or sputtering conductive paste on green sheets; forming conductive via holes in the green sheets such that the internal electrodes can be connected together; and laminating the green sheets.

FIG. 2(b) illustrates a process of pressing the periphery region of the laminated body at a higher pressure than the internal region.

In the pressing process, a flat pressure jig 26 is used to press the periphery region 21b at a higher pressure than the internal region 21a. The flat pressure jig 26 has a ridge 26a at a portion corresponding to the periphery region 21b of the laminated body 21.

The pressure jig 26 may be formed of flexible material, i.e., synthetic resin film such as polypropylene or polyethylene terephthalate. The ridge 26a of the pressure jig 26 serves to press the periphery region 21b earlier than the internal region 21a during the pressing process of the ceramic laminated body 21. Therefore, the lamination heights are different in the periphery region 21b and the internal region 21b.

In this embodiment, the flat pressure jig 26 has the ridge 26a at a portion corresponding to the periphery region 21b of the laminated body 21. The pressure jig 26 can be formed in various shapes only if it can press the periphery region 21b at a higher pressure than the internal region 21a.

FIG. 2(c) illustrates a process of separately firing the periphery region and the internal region of the pressed laminated body.

In this embodiment, an outer loader 22 is mounted on the periphery region of the laminated body 21, which is pressed at a higher pressure than the internal region. An inner loader 23 is mounted on the internal region of the laminated body 21. A top loader 24 is mounted on the outer loader 22 and the inner loader 23.

According to the related art, the ceramic laminated body is pressed by putting a single solid loader covering the panel during the firing process. In this case, since the firing behavior difference occurs in the periphery region and the internal region of the ceramic laminated body, the thickness deviation occurs in the ceramic laminated body. The thickness deviation of the ceramic laminated body reduces the contact rate between the laminated body and the loaders mounted thereon. Consequently, the press effect gradually disappears. Therefore, the shrinkage rates of the internal region and the periphery region of the laminated body become greatly different because the laminated body cannot be pressed uniformly during the firing process.

In this embodiment, the outer loader 22 and the inner loader 23 are separately mounted and the entire substrate is pressed by inserting the inner loader 23 into the outer loader 22. Since the periphery region 21b and the internal region 21a of the laminated body 21 are separately pressed, the periphery region 21b and the internal region 21a can be uniformly pressed even through the thickness deviation occurs in the internal region and the periphery region.

In addition, the top loader 24 may be mounted on the outer loader 22.

The top loader 24 can simultaneously press the outer loader 22 and the inner loader 23 inserted into the opening of the outer loader 22. However, it is desirable that the top loader 24 presses the outer loader 22 pressing the periphery region 21b having a weak binding force.

The periphery region 21b of the laminated body 21 can be pressed at a higher pressure than the internal region 21a by mounting the top loader 24 on the outer loader 22. Therefore, the shrinkage difference between the internal region 21a and the periphery region 21b can be reduced and the entirely flat substrate can be obtained.

Since the top loader 24 mounted on the outer loader 22 has a porous grid structure, organic materials and volatile materials generated during the firing process of the ceramic laminated body 21 can be easily released.

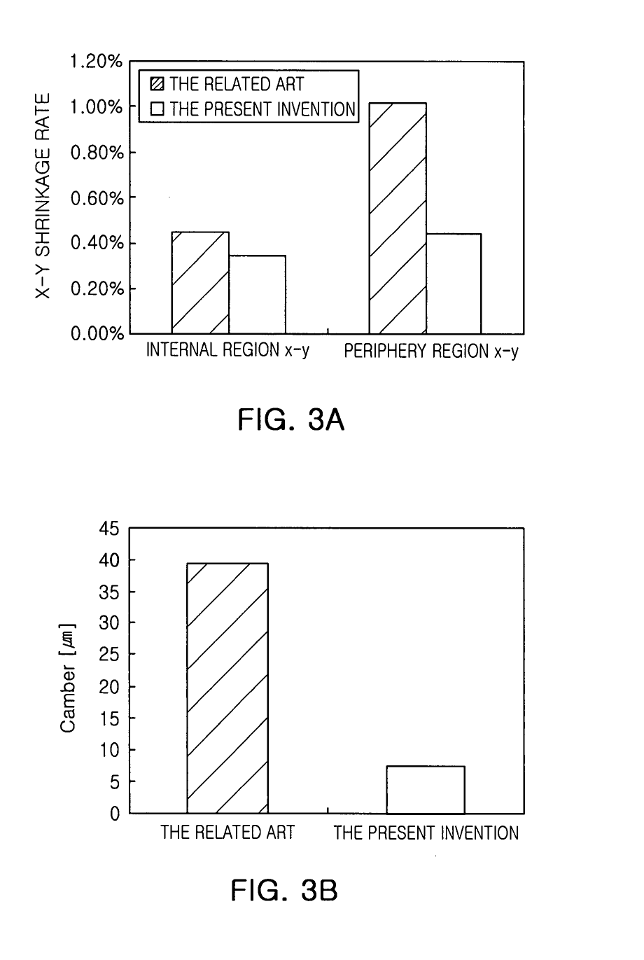

FIG. 3(a) is a graph illustrating the comparison of the shrinkage rate between the laminated ceramic substrate according to the related art and the laminated ceramic substrate according to the embodiment of the present invention. More specifically, FIG. 3(a) illustrates the shrinkage rate of the internal region and the periphery region of the laminated body during the firing process of the laminated ceramic substrate. FIG. 3(b) is a graph illustrating the comparison of the camber between the laminated ceramic substrate according to the related art and the laminated ceramic substrate according to the embodiment of the present invention. In the laminated ceramic substrate according to the related art, the single solid loader covering the entire laminated body is mounted on the ceramic laminated body and fired.

Referring to FIG. 3(a), the laminated ceramic substrate according to the related art has the x-y shrinkage rate of 0.45% in the internal region of the laminated body and the x-y shrinkage rate of 1.00% in the periphery region of the laminated body. However, the laminated ceramic substrate according to the embodiment of the present invention has the x-y shrinkage rate of 0.35% in the internal region of the laminated body and the x-y shrinkage rate of 0.45% in the periphery region of the laminated body.

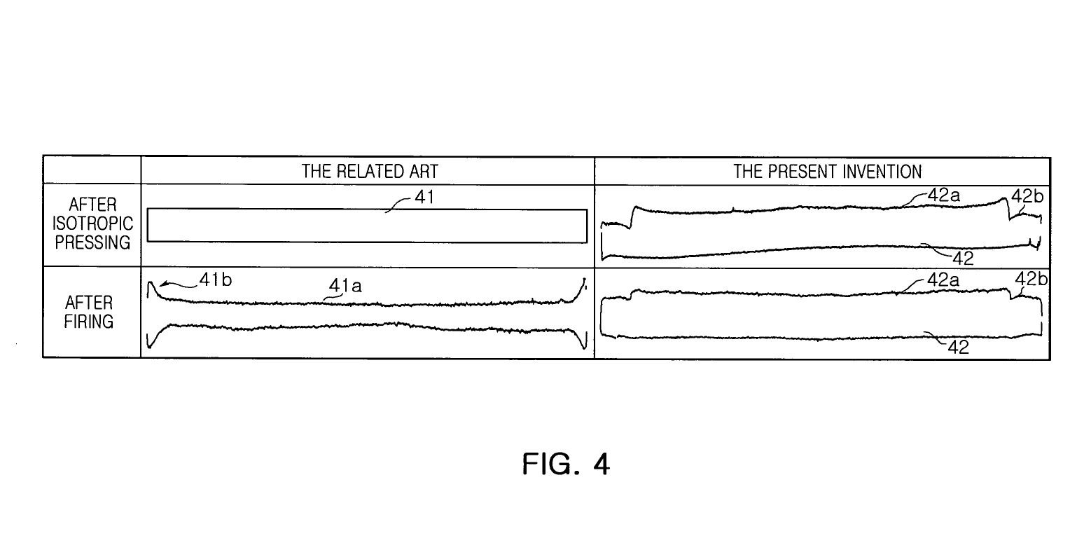

As illustrated in FIG. 4, the planarization of the laminated ceramic substrate according to the related art is poor because the difference of the shrinkage rate between the internal region and the periphery region during the firing process is more than 0.5%.

However, the planarization of the laminated ceramic substrate is excellent because the difference of the shrinkage rate between the internal region and the periphery region is less than 0.1%.

FIG. 3(b) is a graph illustrating the comparison of the camber between the laminated ceramic substrate according to the related art and the laminated ceramic substrate according to the embodiment of the present invention after the firing process. Referring to FIG. 3(b), while the camber of the laminated ceramic substrate according to the related art after the firing process is about 40 μm, the camber of the laminated ceramic substrate according to the embodiment of the present invention is about 7 μm. As can be seen from FIG. 3(b), the camber of the laminated ceramic substrate is significantly reduced.

FIG. 4 is a cross-sectional view illustrating the comparison between the laminated ceramic substrate according to the embodiment of the present invention and the laminated ceramic substrate according to the related art.

The pressing process (see FIG. 2(b)) and the firing process (see FIG. 2(c)) are illustrated in FIG. 4. In the pressing process, the periphery region of the laminated body is pressed at a higher pressure than the internal region. In the firing process, the periphery region and the internal region of the laminated body are separately pressed and fired.

According to the related art, when the laminated body 41 is isotropically pressed and then is fired in such a state that one loader is mounted on the pressed laminated body, the periphery region 41b is further shrunk because its shrinkage rate is higher than that of the internal region 41a. Thus, the planarization of the ceramic substrate after the firing process is poor. In this case, the periphery region 41b of the laminated ceramic substrate must be wrapped and planarized.

According to the embodiment of the present invention, the periphery region 42b of the laminated body 41 is pressed at a higher pressure than the internal region before the firing process. The separate loaders are mounted on the periphery region 42b and the internal region 41a. Compared with the related art, the entire laminated ceramic substrate after the firing process has good planarization.

The jig for pressing the periphery region of the laminated body, the loaders used in the firing process, and the materials of the loaders can be implemented in various ways.

According to the embodiment of the present invention, the periphery region and the internal region of the laminated body are separately pressed using the inner loader and the outer loader during the process of firing the laminated ceramic substrate. Therefore, the pressure loader can uniformly press the laminated body.

Further, the periphery region of the laminated body is pressed at a higher pressure than the internal region before the firing process. During the firing process, the outer loader and the inner loader are separately mounted on the periphery region and the internal region. Therefore, the difference of the shrinkage rate between the internal region and the periphery region of the laminated body can be reduced. Consequently, the entirely flat laminated ceramic substrate can be obtained.

While the present invention has been shown and described in connection with the exemplary embodiments, it will be apparent to those skilled in the art that modifications and variations can be made without departing from the spirit and scope of the invention as defined by the appended claims.

What is claimed is:

1. A pressure loader for firing a laminated ceramic substrate, comprising:
an outer loader mounted on a periphery region of a ceramic laminated body to press the periphery region; and
an inner loader mounted on an internal region of the ceramic laminated body to press the internal region.

2. The pressure loader of claim 1, wherein the outer loader has an opening at a portion corresponding to the internal region of the ceramic laminated body.

3. The pressure loader of claim 2, wherein the internal loader has a block shape such that the internal loader is inserted into the opening of the outer loader.

4. The pressure loader of claim 3, wherein the top surface of the outer loader is higher than that of the inner loader when the outer loader is mounted on the periphery region of the ceramic laminated body.

5. The pressure loader of any one of claims 1, further comprising a top loader mounted on the outer loader to press the outer loader.

6. The pressure loader of claim 5, wherein the top loader has a grid structure.

7. The pressure loader of claim 5, wherein the top loader has a predetermined elasticity such that the top loader simultaneously presses the outer loader and the inner loader.

8. A method of manufacturing a laminated ceramic substrate, comprising:
laminating a plurality of green sheets to form a ceramic laminated body;
primarily pressing the ceramic laminated body such that a periphery region of the ceramic laminated body is formed lower than an internal region of the ceramic laminated body; and
firing the ceramic laminated body in such a state that the periphery region and the internal region of the primarily pressed ceramic laminated body are secondarily pressed.

9. The method of claim 8, wherein the primarily pressing is performed using a jig to press the periphery region of the ceramic laminated body.

10. The method of claim 9, wherein the jig comprises a flat jig having a ridge at a portion corresponding to the periphery region of the ceramic laminated body.

11. The method of claim 8, wherein the secondarily pressing in the firing process is performed by separately mounting loaders on the periphery region and the internal region of the ceramic laminated body.

12. The method of claim 11, wherein the loaders comprise:
an outer loader for pressing the periphery region of the ceramic laminated body; and
an inner loader for pressing the internal region of the ceramic laminated body.

13. The method of claim 12, wherein the outer loader has an opening at a portion corresponding to the internal region of the ceramic laminated body.

14. The method of claim 12, wherein the internal loader has a block shape such that the internal loader is inserted into the opening of the outer loader.

15. The method of claim 12, wherein the top surface of the outer loader is higher than that of the inner loader when the outer loader is mounted on the periphery region of the ceramic laminated body.

16. The method of any one of claims 12, wherein the loaders further comprise a top loader mounted on the outer loader to press the outer loader.

17. The method of claim 16, wherein the top loader has a grid structure.

18. The method of claim 16, wherein the top loader has a predetermined elasticity such that the top loader simultaneously presses the outer loader and the inner loader.
